(19) United States
(12) Patent Application Publication
(10) Pub. No.: US 2025/0285795 A1
(43) Pub. Date: Sep. 11, 2025

(54) NOISE FILTERING ASSEMBLY AND ELECTRICAL DEVICE INCLUDING SAME

(71) Applicant: Rolls-Royce Deutschland Ltd & Co KG, Blankenfelde-Mahlow (DE)

(72) Inventors: Budai DÉNES, Budapest (HU); Balázs BOTKA, Budapest (HU)

(21) Appl. No.: 19/068,504

(22) Filed: Mar. 3, 2025

(30) Foreign Application Priority Data
Mar. 5, 2024 (GB) 2403167.6

(51) Int. Cl. H01F 17/06; H01F 27/26; H01F 27/30

(52) U.S. Cl. CPC H01F 17/06; H01F 27/26; H01F 27/306; H01F 2017/065

(57) ABSTRACT

A noise filtering assembly include at least one core ring partially surrounding an insulator and a plurality of positioning rings disposed on an outer surface of the insulator. Each core ring defines a pair of opposing axial ends along a longitudinal axis and has an inner diameter within a predetermined tolerance range. Each axial end of each core ring is disposed adjacent to an adjacent positioning ring. Each positioning ring includes at least one inclined outer surface inclined at an oblique angle relative to the longitudinal axis. Within the predetermined tolerance range of the inner diameter of each core ring, each axial end of each core ring partially and slidably contacts the at least one inclined outer surface of the adjacent positioning ring.

The present patent document claims the benefit of United Kingdom Patent Application No. 2403167.6, filed Mar. 5, 2024, which is hereby incorporated by reference in its entirety.

### TECHNICAL FIELD

The present disclosure relates to an electrical device in general, and, more specifically, to a noise filtering assembly for filtering electromagnetic noise in an electrical device.

### BACKGROUND

Electrical devices, such as, inverters, generally emit electric fields, magnetic fields, or a combination of both commonly referred to as electromagnetic field. The electromagnetic field emitted by the electrical devices may lead to mutual interference. This interference termed as electromagnetic interference, influences operation of the electrical devices and other neighboring electrical devices, hence needs to be suppressed. Therefore, providing electromagnetic compatibility (EMC) among the electrical devices becomes critical with the advancement of the electrical technology.

Electromagnetic compatible (EMC) filters designed for reducing electromagnetic noise are already known in the art. Use of EMC filters makes electrical devices more reliable and stable by absorbing and shielding high-frequency noise to reduce interference to other nearby electrical devices. These EMC filters, generally, include multiple core rings primarily made of ferrite materials. The core rings control and concentrate the magnetic field by forming a closed magnetic circuit. This enhances the stability and reliability of the electrical devices. Generally, the core rings have relatively high tolerance field or tolerance range, thereby posing a challenge in precise placement of the core rings within the electrical devices.

Conventionally, to overcome this challenge, mechanical holders are used to hold and secure the core rings in place within the electrical devices. However, such mechanical holders may have more mass, leading to increased overall weight of the electrical devices and cost. Moreover, these mechanical holders may not be safe to use as they are sensitive to vibrations. Moreover, such conventional mechanical holders may also take additional space within or around the electrical device.

Therefore, there is a need for a solution that provides precise positioning of the core rings within the electrical device by overcoming above-mentioned limitations.

### SUMMARY AND DESCRIPTION

In view of these challenges, an object of the present disclosure provides a noise filtering assembly for an electrical device to reduce the electromagnetic interference within the electrical device. The scope of the present disclosure is defined solely by the appended claims and is not affected to any degree by the statements within this summary. The present embodiments may obviate one or more of the drawbacks or limitations in the related art.

In accordance with a first aspect of the present disclosure, a noise filtering assembly for filtering electromagnetic noise in an electrical device is disclosed. The noise filtering assembly includes an electrical conductor for conducting current in the electrical device. The electrical conductor defines a longitudinal axis along its length. The noise filtering assembly further includes an insulator at least partially surrounding the electrical conductor and including an outer surface. The noise filtering assembly further includes at least one core ring at least partially surrounding the insulator, such that the electrical conductor and the insulator extend through an opening of the at least one core ring. Each core ring of the at least one core ring defines a pair of opposing axial ends spaced apart from each other along the longitudinal axis. Each core ring has an inner diameter within a predetermined tolerance range. The noise filtering assembly further includes a plurality of positioning rings spaced apart from each other along the longitudinal axis and disposed on the outer surface of the insulator. Each core ring is axially disposed between a corresponding pair of adjacent positioning rings of the plurality of positioning rings along the longitudinal axis, such that each axial end of the pair of opposing axial ends of each core ring is disposed adjacent to an adjacent positioning ring of the corresponding pair of adjacent positioning rings. Each positioning ring includes at least one inclined outer surface inclined at an oblique angle relative to the longitudinal axis. Within the predetermined tolerance range of the inner diameter of each core ring, each axial end of the pair of opposing axial ends of each core ring at least partially and slidably contacts the at least one inclined outer surface of the adjacent positioning ring, such that the plurality of positioning rings supports and centers the at least one core ring relative to the longitudinal axis. The core ring may be a magnetic core ring, including a magnetic core. The core ring may be configured to control and concentrate the magnetic field by forming a closed magnetic circuit.

As the plurality of positioning rings supports and centers the at least one core ring relative to the longitudinal axis, the at least one core ring may be precisely positioned within the electrical device. The placement of the plurality of positioning rings between the at least one core ring and the insulator may compensate for the tolerance range of the inner diameter of each core ring, thereby leading to precise placement and positioning of the at least one core ring over the insulator.

The support provided to the at least one core ring by the plurality of positioning rings may further reduce vibrations during the operation of the electrical device, thereby making the electrical device more stable and reliable. Moreover, the slidable engagement of the at least one inclined outer surface of the positioning ring and the corresponding axial end of the at least one core ring may improve the overall balancing of the electrical device, thereby further improving the stability of the electrical device. The reduced vibrations and improved stability of the electrical device may improve an overall performance of the electrical device. Thus, the noise filtering assembly of the present disclosure may be relatively less sensitive to the vibrations within the electrical device in comparison to conventional mechanical holders used to secure the at least one core ring.

Further, as the noise filtering assembly does not include any mechanical holder to hold and secure the at least one core ring in place within the electrical device, the noise filtering assembly may relatively take less installation space. Moreover, due to this, the noise filtering assembly of the present disclosure may provide an additional advantage of reduced weight and cost of the overall assembly.

In a further development, the plurality of positioning rings includes a pair of end positioning rings including only a single inclined outer surface, such that the at least one inclined outer surface of each end positioning ring of the pair of end positioning rings is the single inclined outer surface. The at least one core ring is axially disposed between the pair of end positioning rings along the longitudinal axis, such that each end positioning ring is disposed adjacent to only a single adjacent core ring of the at least one core ring.

The end positioning ring is used within the noise filtering assembly, when the core ring is disposed only on one side of the positioning ring (i.e., at extreme ends of the noise filtering assembly). Since there is only one adjacent core ring to the end positioning ring, therefore the end positioning ring includes only the single inclined outer surface engaging with the adjacent axial end of the pair of axial ends of each core ring. The inclusion of the pair of end positioning rings may enhance the positioning of the corresponding adjacent core ring.

In a further development, each end positioning ring further includes an orthogonal outer surface intersecting the single inclined outer surface at an apex of the end positioning ring. The orthogonal outer surface is perpendicular to the longitudinal axis and faces away from the single adjacent core ring. The orthogonal outer surface of the end positioning ring is arranged abutting an adjacent surface of the noise filtering assembly, such that it may facilitate a compact assembly of the at least one core ring within the electrical device.

In a further development, the at least one core ring includes a plurality of core rings and the plurality of positioning rings includes one or more intermediate positioning rings, such that each intermediate positioning ring of the one or more intermediate positioning rings is disposed adjacent to and at least partially contacts a corresponding pair of adjacent core rings of the plurality of core rings. Each intermediate positioning ring includes a pair of inclined outer surfaces intersecting at an apex of the intermediate positioning ring, such that the at least one inclined outer surface of each intermediate positioning ring includes the pair of inclined outer surfaces. Each inclined outer surface of the pair of inclined outer surfaces of each intermediate positioning ring at least partially and slidably contacts an adjacent core ring of the corresponding pair of adjacent core rings.

As each inclined outer surface of the pair of inclined outer surfaces of each intermediate positioning ring at least partially and slidably contacts the adjacent core ring of the corresponding pair of adjacent core rings, the at least one core ring may be positioned and placed precisely so as to cause minimal vibrations in the electrical device.

In a further development, the oblique angles formed by the pair of inclined outer surfaces of each intermediate positioning ring have a same magnitude. The same magnitude of the oblique angles formed by the pair of inclined outer surfaces of each intermediate positioning ring may facilitate centering of the at least one core ring relative to the longitudinal axis, which may further improve the overall balancing of the system and the stability of the electrical device.

In a further development, each positioning ring is made of a polymeric material or a composite material. The polymeric material and the composite material may be light weight and temperature resistant. This may help in enabling a safe operation of the electrical device and maintaining the overall weight of the electrical device at lower levels.

In a further development, the oblique angle of inclination of each positioning ring is in a range of 25 degrees to 75 degrees. Such range of the oblique angle of inclination of each positioning ring may facilitate positioning and centering of each core ring in the noise filtering assembly. The oblique angle of inclination of each positioning ring may be selected based on application requirements.

In a further development, each positioning ring has an outer diameter that is equal to or greater than the inner diameter of each core ring. This enables each positioning ring to form an interference fit with the corresponding core ring, thereby facilitating positioning and centering of each core ring in the noise filtering assembly.

In a further development, at least one positioning ring of the plurality of positioning rings includes a cut-out, such that the at least one positioning ring is a split ring. The cut-out may facilitate change in the outer diameter of the at least one positioning ring due to a compressive force applied on the inclined outer surface of the at least one positioning ring during engagement of the positioning ring with the corresponding core ring. This may enable the at least one positioning ring with the cut-out to compensate for higher tolerance of the inner diameter of each core ring. In other words, during engagement of the at least one positioning ring with the corresponding core ring, absorption tolerance of the at least one positioning ring may be further increased by providing the cut-out.

In a further development, a circumferential length of the cut-out is in a range of 2% to 30% or in a range of 5% to 10% of a total circumferential length of the at least one positioning ring. The circumferential length of the cut-out of the at least one positioning ring may be selected based on application requirements.

In a further development, each axial end of each core ring includes an inner rounded corner surface disposed proximal to the outer surface of the insulator. The inner rounded corner surface at least partially and slidably contacts the at least one inclined outer surface of the adjacent positioning ring. The inner rounded corner surface of each core ring may facilitate a smooth slidable contact between the core ring and the at least one inclined outer surface of the adjacent positioning ring. Moreover, the inner rounded corner surface may reduce stress concentration at each axial end of each core ring, thereby making it less prone to cracks.

In a further development, each core ring includes a magnetic core, e.g., a ferrite core. The magnetic or ferrite core may be of a high frequency ferrite composition having an ability to suppress electromagnetic noise. Therefore, the magnetic or ferrite core may be used in the electrical device to absorb and shield high-frequency noise and interference to reduce interference with another electrical device. This may make the electronic device more stable and reliable, and moreover improve its performance and anti-interference ability.

In a further development, the electrical conductor is a busbar. The busbar may be a panel board, distribution board, and the like. The busbar may be a plate-shaped or rod-shaped conductor.

In a further development, the noise filtering assembly further includes a pair of nuts fastened to the insulator and axially spaced apart from each other. At least one core ring and the plurality of positioning rings are axially secured between the pair of nuts along the longitudinal axis. The pair of nuts may provide an axial compressive force to keep or maintain the position of each core ring and corresponding positioning ring within the electrical device.

In a further development, each positioning ring has a triangular cross-section. The triangular cross-section of the positioning ring may help in precise positioning of each core ring on the at least one inclined surface of the adjacent positioning ring within the predetermined tolerance range of the inner diameter of each core ring, which may further facilitate centering of each core ring relative to the longitudinal axis.

According to a second aspect, an electrical device including the noise filtering assembly of the first aspect is disclosed. The inclusion of the noise filtering assembly of the first aspect in the electrical device may improve functional performance of the electrical device. The noise filtering assembly may be integrated into the electrical device to filter the electromagnetic noise emitted by the electrical device or various components of the electrical device.

In a further development, the electrical device is an inverter. The inverter may be a power converter which uses an AC voltage or DC voltage to produce an AC voltage, the frequency and amplitude of which are varied. The inverter may be in the form of AC/DC-DC/AC converters or DC/AC converters, wherein an output AC voltage is produced from an input AC voltage or an input DC voltage.

The noise filtering assembly according to the first aspect of the disclosure and the electrical device according to the second aspect of the disclosure may include identical or similar developments, in particular as described in the dependent claims. Therefore, a development of one aspect of the disclosure is also applicable to another aspect of the disclosure.

These and other aspects of the disclosure become apparent from and elucidated with reference to the embodiments described hereinafter. The embodiments of the disclosure are described in the following based on the drawings. The latter is not necessarily intended to represent the embodiments to scale. Drawings are, where useful for explanation, shown in schematized and/or slightly distorted form. With regard to additions to the teachings immediately recognizable from the drawings, reference is made to the relevant state-of-the-art. Numerous modifications and changes may be made to the form and detail of an embodiment without deviating from the general idea of the disclosure. The features of the disclosure in the description, in the drawings, and in the claims may be essential for a further development of the disclosure either individually or in any combination.

In addition, all combinations of at least two of the features disclosed in the description, drawings, and/or claims fall within the scope of the disclosure. The general idea of the disclosure is not limited to the exact form or detail of the embodiments shown and described below, or to an object which would be limited in comparison to the object claimed in the claims. For specified design ranges, values within the specified limits are also disclosed as limit values and thus arbitrarily applicable and claimable.

### BRIEF DESCRIPTION OF THE DRAWINGS

Further advantages, features, and details of the disclosure result from the following description of the embodiments as well as from the drawings.

FIG. 1 depicts a block diagram of an electrical device, according to an embodiment.

FIG. 2 depicts a perspective side view of a noise filtering assembly of the electrical device of FIG. 1, according to an embodiment.

FIG. 3 depicts an exploded view of the noise filtering assembly of FIG. 2, according to an embodiment.

FIG. 4 depicts a partial sectional side view of the noise filtering assembly, according to an embodiment.

FIG. 5A depicts a sectional side view of the noise filtering assembly depicting a maximum inner diameter of at least one core ring thereof, according to an embodiment.

FIG. 5B depicts a sectional side view of the noise filtering assembly depicting a minimum inner diameter of the at least one core ring thereof, according to an embodiment.

FIG. 6A depicts a perspective view of an end positioning ring of the noise filtering assembly, according to an embodiment.

FIG. 6B depicts a side view of the end positioning ring of FIG. 6A, according to an embodiment.

FIG. 6C depicts a perspective view of an intermediate positioning ring of the noise filtering assembly, according to another embodiment.

FIG. 6D depicts a side view of the intermediate positioning ring of FIG. 6C, according to an embodiment.

FIG. 7A depicts a perspective view of a positioning ring of the noise filtering assembly, according to another embodiment.

FIG. 7B depicts a front view of the positioning ring of FIG. 7A, according to an embodiment.

The following table lists the reference numerals used in the drawings with the features to which they refer:

| Ref no. | Feature |
|---|---|
| 50 | Electrical device |
| 100 | Noise filtering assembly |
| 102 | Electrical conductor |
| 104 | Insulator |
| 106 | Core ring |
| 110 | Positioning ring |
| 110′ | Positioning ring |
| 112 | Outer surface of insulator |
| 114 | Opening |
| 116 | Axial end |
| 118 | Axial end |
| 120 | Inner rounded corner surface |
| 122 | Planar surface |
| 124 | Outer rounded corner surface |
| 126 | Inner core surface |
| 128 | Outer core surface |
| 130 | Nut |
| 132 | Nut |
| 134 | Inner surface of positioning ring |
| 136 | Inclined outer surface |
| 140 | End positioning ring |
| 142 | Orthogonal outer surface |
| 144 | Apex |
| 150 | Intermediate positioning ring |
| 152 | Cut-out |
| CL | Circumferential length |
| ID | Inner diameter of core ring |
| IDₘᵢₙ | Minimum inner diameter of core ring |
| IDₘₐₓ | Maximum inner diameter of core |
| | ring |
| OD | Outer diameter of positioning ring |
| L-L | Longitudinal axis |
| TCL | Total circumferential length |
| TR | Tolerance range |
| θ | Oblique angle |

### DETAILED DESCRIPTION

Aspects and embodiments of the present disclosure are now discussed with reference to the accompanying figures. Further aspects and embodiments will be apparent to those skilled in the art.

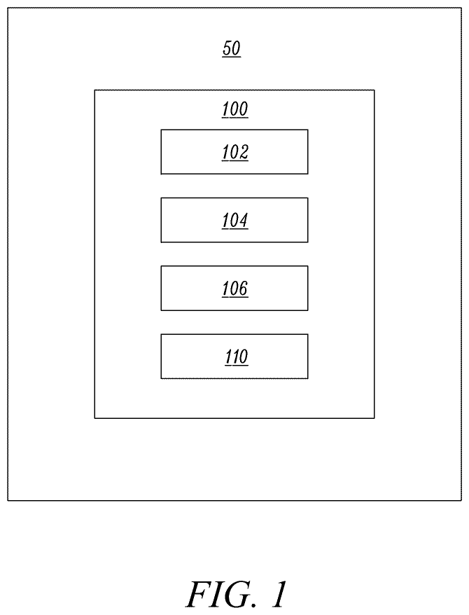

FIG. 1 shows a block diagram of an electrical device 50 according to an embodiment of the disclosure. In the illustrated embodiment of FIG. 1, the electrical device 50 is an inverter. In other embodiments, the electrical device 50 may be an electrical device having a circuit, for example, a power electronic converter emitting electromagnetic noise. In some embodiments, the electrical device 50 may be a device employing digital techniques, such as a computing device, or a telecommunication device causing electromagnetic noise. The electrical device 50 includes a noise filtering assembly 100 for filtering electromagnetic noise in the electrical device 50.

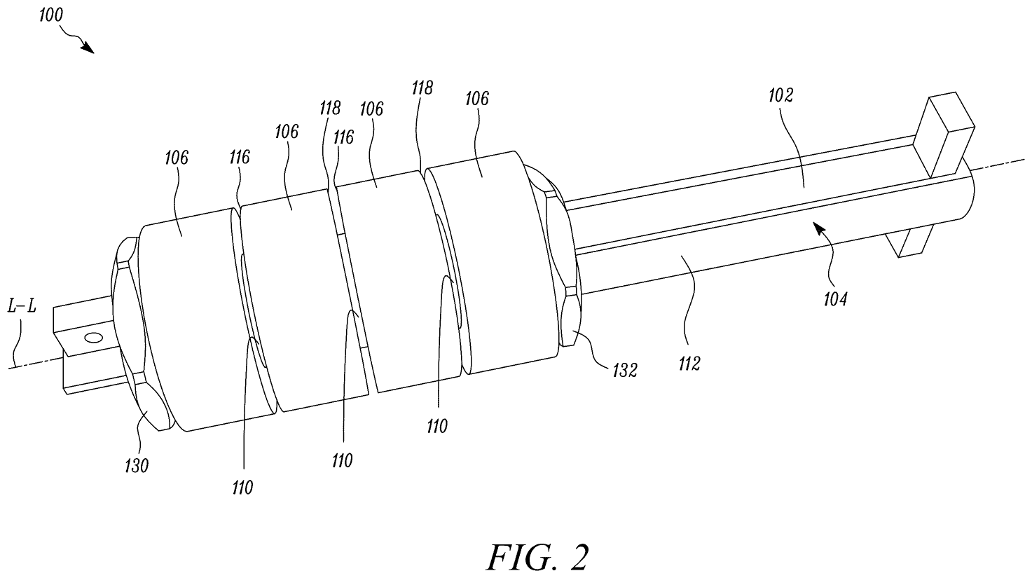

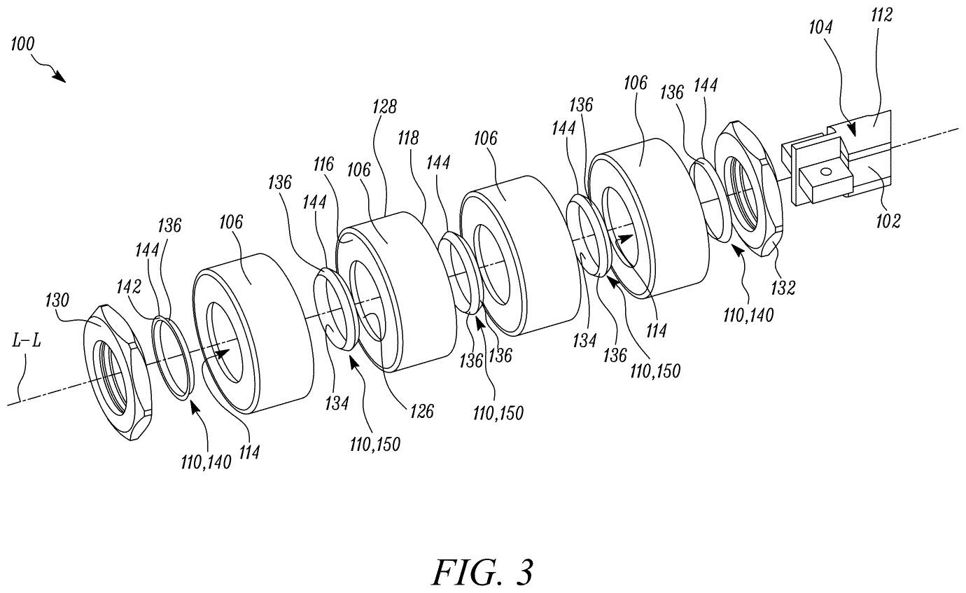

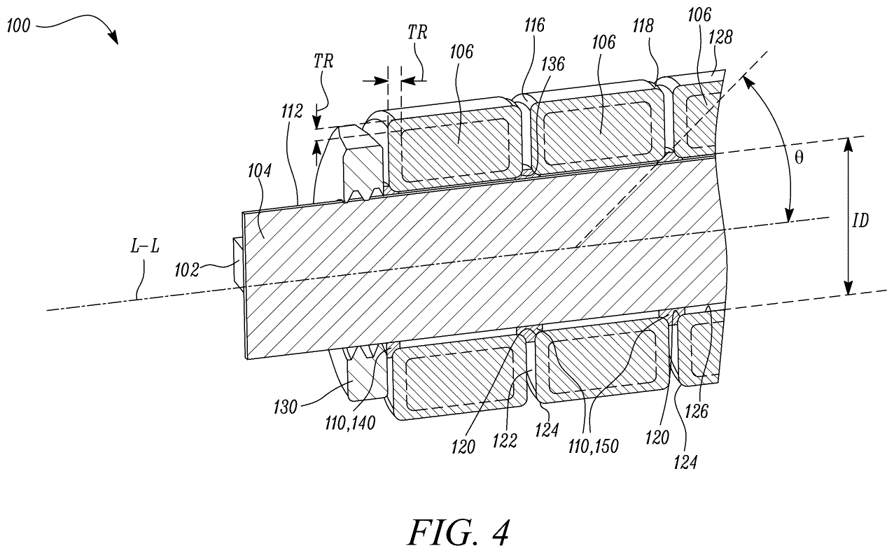

FIG. 2 shows a perspective side view of the noise filtering assembly 100, according to an embodiment of the disclosure. FIG. 3 shows an exploded view of the noise filtering assembly 100, according to an embodiment of the disclosure. FIG. 4 shows a partial sectional side view of the noise filtering assembly 100, according to an embodiment of the disclosure. Referring to FIGS. 1 to 4, the noise filtering assembly 100 includes an electric conductor 102 for conducting current in the electrical device 50, an insulator 104 at least partially surrounding the electrical conductor 102, at least one core ring 106 at least partially surrounding the insulator 104, and a plurality of positioning rings 110.

The electrical conductor 102 defines a longitudinal axis L-L along its length. As shown in FIG. 2, the electrical conductor 102 is a bus bar. The insulator 104 is arranged to provide insulation between the electrical conductor 102 and the at least one core ring 106. The insulator 104 includes an outer surface 112. The electrical conductor 102 and the insulator 104 extend through an opening 114 (shown in FIG. 3) of the at least one core ring 106. In some embodiments, the at least one core ring 106 includes a plurality of core rings 106. In other embodiments, the at least one core ring 106 includes only a single core ring 106. In the illustrated embodiment of FIG. 2, the at least one core ring 106 includes four core rings in total. However, in other embodiments, the at least one core ring 106 may include three core rings, five core rings, or more than five core rings. In some embodiments, each core ring 106 includes a magnetic core in the form of a ferrite core. The ferrite core may be of a high frequency ferrite composition having an ability to suppress electromagnetic noise in the electrical device 50.

Each core ring 106 of the at least one core ring defines 106 a pair of opposing axial ends 116, 118 spaced apart from each other along the longitudinal axis L-L. In some embodiments, each axial end 116, 118 of each core ring 106 includes an inner rounded corner surface 120 (shown in FIG. 4) disposed proximal to the outer surface 112 of the insulator 104. In some embodiments, each axial end 116, 118 of each core ring 106 further includes a planar surface 122 (shown in FIG. 4) extending from the inner rounded corner surface 120 away from the insulator 104 and an outer rounded corner surface 124 (shown in FIG. 4) extending from the planar surface 122 opposite to the inner rounded corner surface 120. Accordingly, each core ring 106 has a rectangular cross-section with rounded corners. In other embodiments, each core ring 106 may have another regular shape cross-section, such as, circular, elliptical, square, etc.

Further, each core ring 106 includes an inner core surface 126 arranged proximate to the outer surface 112 of the insulator 104 and an outer core surface 128 disposed opposite to the inner core surface 126. The inner core surface 126 and the outer core surface 128 of each core ring 106 extend along the longitudinal axis L-L between the axial ends 116, 118 of the corresponding core rings 106. Each core ring 106 further defines an inner diameter ID within a predetermined tolerance range TR. The inner diameter ID corresponds to the inner core surface 126 of the core rings 106. The predetermined tolerance range TR is selected based on various application attributes and design limitations.

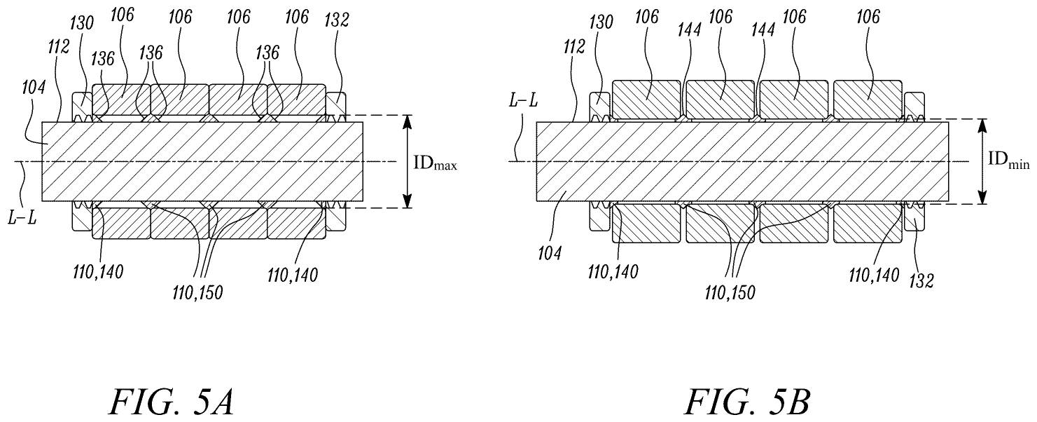

FIG. 5A shows a sectional side view of the noise filtering assembly 100 depicting a maximum inner diameter IDₘₐₓ of the at least one core ring 106, according to an embodiment of the disclosure. FIG. 5B shows a sectional side view of the noise filtering assembly 100 depicting a minimum inner diameter IDₘᵢₙ of the at least one core ring 106, according to an embodiment of the disclosure. As shown in FIGS. 5A and 5B, the inner diameter ID of each core ring 106 varies between the minimum inner diameter IDₘᵢₙ and the maximum inner diameter IDₘₐₓ as per the predetermined tolerance range TR of each core ring 106. This variation in the inner diameter ID of the at least one core ring 106 within the predetermined tolerance range TR may affect the precise placement of the at least one core ring 106 over the insulator 104 within the electrical device 50.

Referring to FIGS. 1 to 5B, to compensate for the predetermined tolerance range TR of the at least one core ring 106 and facilitate precise placement of the at least one core ring 106 over the insulator 104, the plurality of positioning rings 110 is disposed on the outer surface 112 of the insulator 104. The plurality of positioning rings 110 is spaced apart from each other along the longitudinal axis L-L. The plurality of positioning rings 110 is axially alternating with the at least one core ring 106 along the longitudinal axis L-L. In other words, each core ring 106 is axially disposed between a corresponding pair of adjacent positioning rings 110 of the plurality of positioning rings 110 along the longitudinal axis L-L. Accordingly, each axial end of the pair of opposing axial ends 116, 118 of each core ring 106 is disposed adjacent to an adjacent positioning ring 110 of the corresponding pair of adjacent positioning rings 110.

In some embodiments, each positioning ring 110 is made of a polymeric material or a composite material. The polymeric material and the composite material may be light weight and temperature resistant. Hence, the use of positioning ring 110 made of polymeric material or composite material may enable a safe operation of the electrical device 50 and maintain the overall weight of the electrical device 50 at lower levels.

The noise filtering assembly 100 further includes a pair of nuts 130, 132 fastened to the insulator 104 and axially spaced apart from each other. The at least one core ring 106 and the plurality of positioning rings 110 are axially secured between the pair of nuts 130, 132 along the longitudinal axis L-L. The pair of nuts 130, 132 may provide an axial compressive force to keep or maintain the position of each core ring 106 and the corresponding positioning ring 110 within the electrical device 50.

Each positioning ring 110 further includes an inner surface 134 arranged at least partially contacting the outer surface 112 of the insulator 104. Each positioning ring 110 further includes at least one inclined outer surface 136 inclined at an oblique angle θ (shown in FIG. 4) relative to the longitudinal axis L-L. In some embodiments, the oblique angle θ of inclination of each positioning ring 110 is from 25 degrees to 75 degrees. In other embodiments, the oblique angle θ of inclination of each positioning ring 110 may be from 20 degrees to 80 degrees. In the illustrated embodiment of FIG. 4, the oblique angle θ of inclination of each positioning ring 110 is 45 degrees. In some embodiments, each positioning ring 110 has a triangular cross-section.

In some embodiments, each positioning ring 110 has an outer diameter OD that is equal to or greater than the inner diameter ID of each core ring 106. Due to this, each positioning ring 110 forms an interference fit with the corresponding core ring 106 that may further facilitate centering of each core ring 106 relative to the longitudinal axis L-L.

Within the predetermined tolerance range TR of the inner diameter ID of each core ring 106, each axial end of the pair of opposing axial ends 116, 118 of each core ring 106 at least partially and slidably contacts the at least one inclined outer surface 136 of the adjacent positioning ring 110, such that the plurality of positioning rings 110 supports and centers the at least one core ring 106 relative to the longitudinal axis L-L. Further, the inner rounded corner surface 120 at least partially and slidably contacts the at least one inclined outer surface 136 of the adjacent positioning ring 110. More specifically, the inner rounded corner surface 120 of each core ring 106 engages the at least one inclined outer surface 136 of the adjacent positioning ring 110. In other words, the inner rounded corner surface 120 of each core ring 106 rests on the at least one inclined outer surface 136 of the adjacent positioning ring 110.

As the plurality of positioning rings 110 supports and centers the at least one core ring 106 relative to the longitudinal axis L-L, the at least one core ring 106 may be precisely positioned within the electrical device 50. The placement of the plurality of positioning rings 110 between the at least one core ring 106 and the insulator 104 may compensate for the tolerance range of the inner diameter ID of each core ring 106, thereby leading to precise placement and positioning of the at least one core ring 106 over the insulator 104. The support provided to the at least one core ring 106 by the plurality of positioning rings 110 may further reduce vibrations during the operation of the electrical device 50, thereby making the electrical device 50 more stable and reliable.

Moreover, the slidable engagement of the at least one inclined outer surface 136 of the positioning ring 110 and the corresponding axial end 116, 118 of the at least one core ring 106 may improve the overall balancing of the electrical device 50, thereby further improving the stability of the electrical device 50. The reduced vibrations and improved stability of the electrical device 50 may improve an overall performance of the electrical device 50. Thus, the noise filtering assembly 100 may be relatively less sensitive to vibrations within the electrical device 50 in comparison to conventional mechanical holders used to secure the at least one core ring 106. Further, the inner rounded corner surface 120 of each core ring 106 may facilitate a smooth slidable contact between the core ring 106 and the at least one inclined outer surface 136 of the adjacent positioning ring 110, which may reduce stress concentration at each axial end 116, 118 of each core ring 106, thereby making it less prone to cracks.

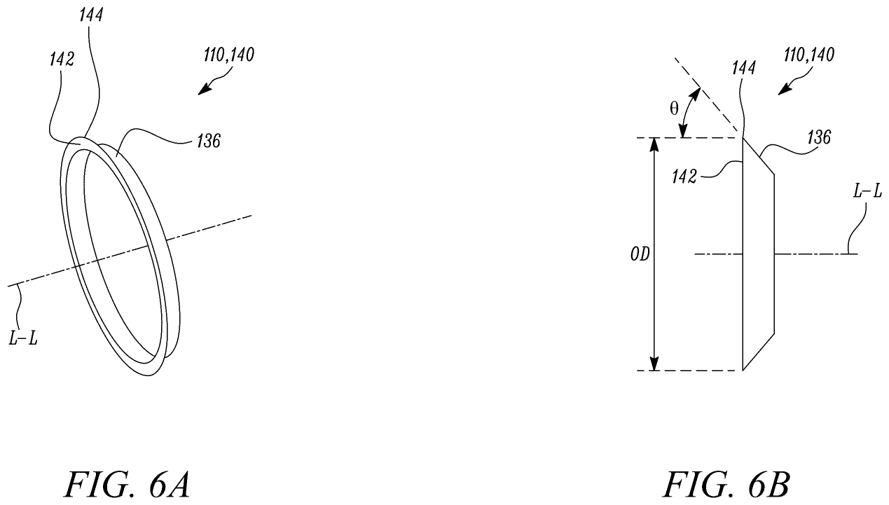

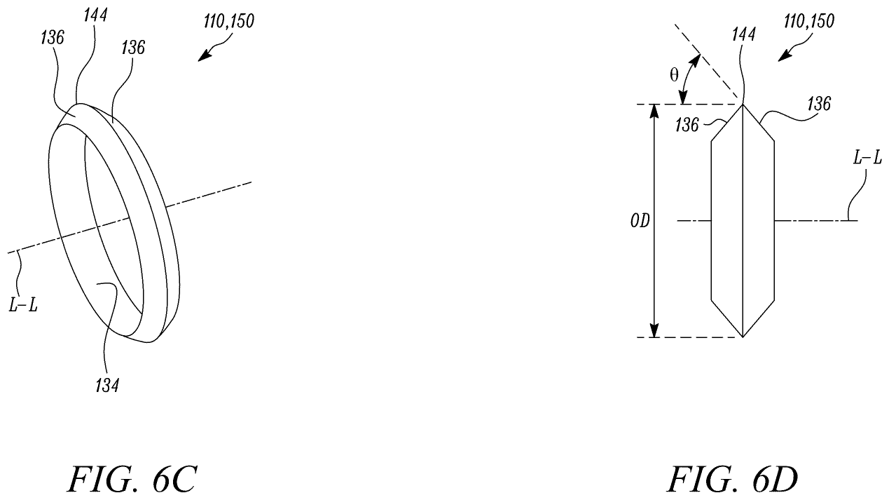

In some embodiments, the plurality of positioning rings 110 includes a pair of end positioning rings 140 (also shown in FIG. 3) including only a single inclined outer surface 136, such that the at least one inclined outer surface 136 of each end positioning ring 140 of the pair of end positioning rings 140 is the single inclined outer surface 136. FIG. 6A shows a perspective view of the end positioning ring 140, according to an embodiment of the disclosure. FIG. 6B shows a side view of the end positioning ring 140.

Referring to FIGS. 1 to 6B, the at least one core ring 106 is axially disposed between the pair of end positioning rings 140 along the longitudinal axis L-L, such that each end positioning ring 140 is disposed adjacent to only a single adjacent core ring 106 of the at least one core ring 106. In some embodiments, each end positioning ring 140 further includes an orthogonal outer surface 142 intersecting the single inclined outer surface 136 at an apex 144 of the end positioning ring 140. Use of the end positioning ring 140 having only a single inclined outer surface 136 engaging with the adjacent axial end of the pair of axial ends 116, 118 of each core ring may save valuable space within the noise filtering assembly 100.

The orthogonal outer surface 142 is perpendicular to the longitudinal axis L-L and faces away from the single adjacent core ring 106. Accordingly, each end positioning ring 140 may have a right-angle triangular cross-section. The orthogonal outer surface 142 is arranged abutting an adjacent nut of the pair of nuts 130, 132, such that it enables a frictional contact with the adjacent nut of the pair of nuts 130, 132. Such frictional contact with the adjacent nut of the pair of nuts 130, 132, facilitates compact assembly of the noise filtering assembly 100 within the electrical device 50.

In some embodiments, when the at least one core ring 106 includes a plurality of core rings 106, the plurality of positioning rings 110 includes one or more intermediate positioning rings 150 (also shown in FIG. 3), such that each intermediate positioning ring 150 of the one or more intermediate positioning rings 150 is disposed adjacent to and at least partially contacts a corresponding pair of adjacent core rings 106 of the plurality of core rings 106. FIG. 6C shows a perspective view of the intermediate positioning ring 150, according to an embodiment of the disclosure. FIG. 6D shows a side view of the intermediate positioning ring 150.

Each intermediate positioning ring 150 includes a pair of inclined outer surfaces 136 intersecting at the apex 144 of the intermediate positioning ring 150, such that the at least one inclined outer surface 136 of each intermediate positioning ring 150 includes the pair of inclined outer surfaces 136. Each inclined outer surface 136 of the pair of inclined outer surfaces 136 of each intermediate positioning ring 150 at least partially and slidably contacts an adjacent core ring 106 of the corresponding pair of adjacent core rings 106.

In some embodiments, the oblique angles θ formed by the pair of inclined outer surfaces 136 of each intermediate positioning ring 150 have the same magnitude. Accordingly, each intermediate positioning ring 150 may have an isosceles-triangular cross-section. In some embodiments, the oblique angle θ of inclination of each intermediate positioning ring 150 is from 25 degrees to 75 degrees. In some embodiments, the oblique angle θ of inclination of each intermediate positioning ring 150 may be from 20 degrees to 80 degrees. In some embodiments, the oblique angle θ of inclination of each intermediate positioning ring 150 is 45 degrees.

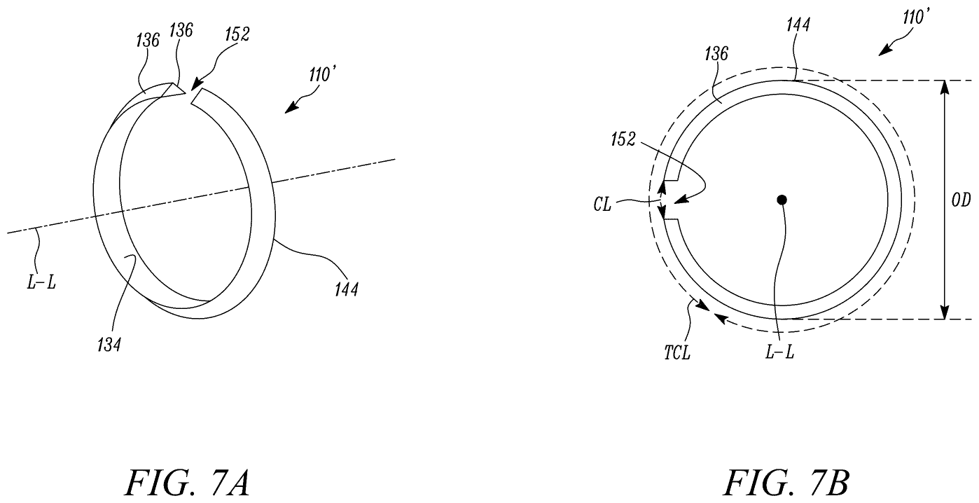

FIG. 7A shows a perspective view of a positioning ring 110′, according to another embodiment of the disclosure. FIG. 7B shows a front view of the positioning ring 110′. The positioning ring 110′ may be interchangeably referred to herein as “at least one positioning ring 110′”. The positioning ring 110′ is substantially similar to the positioning ring 110 shown in FIG. 6A, with common components being referred to by the same numerals. However, the at least one positioning ring 110′ (i.e., the positioning ring 110′) of the plurality of positioning rings 110 includes a cut-out 152, such that the at least one positioning ring 110′ is a split ring.

The cut-out 152 separates extreme circumferential ends of the at least one positioning ring 110′ from each other, thereby facilitating change in the outer diameter OD of the at least one positioning ring 110′ due to a compressive force applied on the inclined outer surface 136 of the at least one positioning ring 110′ during engagement of each core ring 106 with the corresponding at least one positioning ring 110′. This may enable the at least one positioning ring 110′ to compensate for higher tolerance of the inner diameter ID (shown in FIG. 4) of each core ring 106. In other words, during engagement of the at least one positioning ring 110′ with the corresponding core ring 106, absorption tolerance of the at least one positioning ring 110′ may be further increased by providing the cut-out 152. In some embodiments, a circumferential length CL of the cut-out 152 is in a range of 2% to 30% or in a range of 5% to 10% of a total circumferential length TCL of the at least one positioning ring 110′. In the illustrated embodiment, as shown in FIGS. 7A and 7B, the circumferential length CL of the cut-out 152 may be 8% of the total circumferential length TCL of the at least one positioning ring 110′. The circumferential length CL of the cut-out 152 of the at least one positioning ring 110′ may be selected based on application requirements.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A noise filtering assembly for filtering electromagnetic noise in an electrical device, the noise filtering assembly comprising:
an electrical conductor for conducting current in the electrical device, the electrical conductor having a longitudinal axis along a length of the electrical conductor;
an insulator at least partially surrounding the electrical conductor and comprising an outer surface;
at least one core ring configured to control and concentrate a magnetic field by forming a closed magnetic circuit and at least partially surrounding the insulator, such that the electrical conductor and the insulator extend through an opening of the at least one core ring, wherein each core ring of the at least one core ring comprises a pair of opposing axial ends spaced apart from each other along the longitudinal axis, and wherein each core ring has an inner diameter within a predetermined tolerance range; and
a plurality of positioning rings spaced apart from each other along the longitudinal axis and disposed on the outer surface of the insulator, wherein each core ring is axially disposed between a corresponding pair of adjacent positioning rings of the plurality of positioning rings along the longitudinal axis, such that each axial end of the pair of opposing axial ends of each core ring is disposed adjacent to an adjacent positioning ring of the corresponding pair of adjacent positioning rings,
wherein each positioning ring of the plurality of positioning rings comprises at least one inclined outer surface inclined at an oblique angle relative to the longitudinal axis, and
wherein, within the predetermined tolerance range of the inner diameter of each core ring, each axial end of the pair of opposing axial ends of each core ring at least partially and slidably contacts the at least one inclined outer surface of the adjacent positioning ring, such that the plurality of positioning rings supports and centers the at least one core ring relative to the longitudinal axis.

2. The noise filtering assembly of claim 1, wherein the plurality of positioning rings comprises a pair of end positioning rings comprising only a single inclined outer surface, such that the at least one inclined outer surface of each end positioning ring of the pair of end positioning rings is the single inclined outer surface, and
wherein the at least one core ring is axially disposed between the pair of end positioning rings along the longitudinal axis, such that each end positioning ring is disposed adjacent to only a single adjacent core ring of the at least one core ring.

3. The noise filtering assembly of claim 2, wherein each end positioning ring further comprises an orthogonal outer surface intersecting the single inclined outer surface at an apex of the end positioning ring, and
wherein the orthogonal outer surface is perpendicular to the longitudinal axis and faces away from the single adjacent core ring.

4. The noise filtering assembly of claim 1, wherein the at least one core ring comprises a plurality of core rings,
wherein the plurality of positioning rings comprises one or more intermediate positioning rings, such that each intermediate positioning ring of the one or more intermediate positioning rings is disposed adjacent to and at least partially contacts a corresponding pair of adjacent core rings of the plurality of core rings,
wherein each intermediate positioning ring comprises a pair of inclined outer surfaces intersecting at an apex of the intermediate positioning ring, such that the at least one inclined outer surface of each intermediate positioning ring comprises the pair of inclined outer surfaces, and
wherein each inclined outer surface of the pair of inclined outer surfaces of each intermediate positioning ring at least partially and slidably contacts an adjacent core ring of the corresponding pair of adjacent core rings.

5. The noise filtering assembly of claim 4, wherein oblique angles formed by the pair of inclined outer surfaces of each intermediate positioning ring of the one or more intermediate positioning rings have a same magnitude.

6. The noise filtering assembly of claim 1, wherein each positioning ring of the plurality of positioning rings comprises a polymeric material or a composite material.

7. The noise filtering assembly of claim 1, wherein the oblique angle of inclination of each positioning ring of the plurality of positioning rings is in range from 25 degrees to 75 degrees.

8. The noise filtering assembly of claim 1, wherein each positioning ring of the plurality of positioning rings has an outer diameter that is equal to or greater than the inner diameter of each core ring of the at least one core ring.

9. The noise filtering assembly of claim 1, wherein at least one positioning ring of the plurality of positioning rings comprises a cut-out, such that the at least one positioning ring is a split ring.

10. The noise filtering assembly of claim 9, wherein a circumferential length of the cut-out is in a range of 2% to 30% of a total circumferential length of the at least one positioning ring.

11. The noise filtering assembly of claim 9, wherein a circumferential length of the cut-out is in a range of 5% to 10% of a total circumferential length of the at least one positioning ring.

12. The noise filtering assembly of claim 1, wherein each axial end of each core ring of the at least one core ring comprises an inner rounded corner surface disposed proximal to the outer surface of the insulator, and
wherein the inner rounded corner surface at least partially and slidably contacts the at least one inclined outer surface of the adjacent positioning ring of the plurality of positioning rings.

13. The noise filtering assembly of claim 1, wherein each core ring of the at least one core ring comprises a magnetic core and/or a ferrite core.

14. The noise filtering assembly of claim 1, wherein the electrical conductor is a busbar.

15. The noise filtering assembly of claim 1, further comprising:
a pair of nuts fastened to the insulator and axially spaced apart from each other,
wherein the at least one core ring and the plurality of positioning rings are axially secured between the pair of nuts along the longitudinal axis.

16. The noise filtering assembly of claim 1, wherein each positioning ring of the plurality of positioning rings has a triangular cross-section.

17. An electrical device comprising:
a noise filtering assembly having:
an electrical conductor for conducting current in the electrical device, the electrical conductor having a longitudinal axis along a length of the electrical conductor;
an insulator at least partially surrounding the electrical conductor and comprising an outer surface;
at least one core ring configured to control and concentrate a magnetic field by forming a closed magnetic circuit and at least partially surrounding the insulator, such that the electrical conductor and the insulator extend through an opening of the at least one core ring, wherein each core ring of the at least one core ring comprises a pair of opposing axial ends spaced apart from each other along the longitudinal axis, and wherein each core ring has an inner diameter within a predetermined tolerance range; and
a plurality of positioning rings spaced apart from each other along the longitudinal axis and disposed on the outer surface of the insulator, wherein each core ring is axially disposed between a corresponding pair of adjacent positioning rings of the plurality of positioning rings along the longitudinal axis, such that each axial end of the pair of opposing axial ends of each core ring is disposed adjacent to an adjacent positioning ring of the corresponding pair of adjacent positioning rings,
wherein each positioning ring of the plurality of positioning rings comprises at least one inclined outer surface inclined at an oblique angle relative to the longitudinal axis, and
wherein, within the predetermined tolerance range of the inner diameter of each core ring, each axial end of the pair of opposing axial ends of each core ring at least partially and slidably contacts the at least one inclined outer surface of the adjacent positioning ring, such that the plurality of positioning rings supports and centers the at least one core ring relative to the longitudinal axis.

18. The electrical device of claim 17, wherein the electrical device is an inverter.
